(19) United States
(12) Patent Application Publication
(10) Pub. No.: US 2006/0265567 A1
(43) Pub. Date: Nov. 23, 2006

(54) Image forming apparatus and method of recognizing partitions in an external memory device connected thereto

(76) Inventor: Jong-heon Ji, Anyang-si (KR)

Correspondence Address: STANZIONE & KIM, LLP, 919 18TH STREET, N.W., SUITE 440, WASHINGTON, DC, 20006, US

(21) Appl. No.: 11/353,122

(22) Filed: Feb. 14, 2006

(30) Foreign Application Priority Data
May 19, 2005 (KR) 2005-42228

(51) Int. Cl. G06F 12/00

(52) U.S. Cl. 711/173; 711/115

(57) ABSTRACT

An image forming apparatus that recognizes partitions in an external memory device connected to the image forming apparatus. The image forming apparatus includes an interface to connect an external memory device to the image forming apparatus, a partition counter to calculate the number of partitions in the connected external memory device, and a display unit to display the calculated partitions.

### CROSS-REFERENCE TO RELATED APPLICATIONS

This application claims the benefit of Korean Patent Application No. 2005-42228, filed on May 19, 2005, in the Korean Intellectual Property Office, the entire contents of which are incorporated herein by reference.

### BACKGROUND OF THE INVENTION

1. Field of the Invention

The present general inventive concept relates to an image forming apparatus and a method of recognizing partitions in an external memory device connected thereto. More specifically, the general inventive concept relates to an image forming apparatus, and a method of recognizing partitions in a plurality of external memory devices connected thereto and displaying contents of the plurality of external memory devices on a user interface.

2. Description of the Related Art

Generally, a USB (Universal Serial Bus) system is a system that conveniently connects peripheral devices to a computer. Centering on a USB host, external devices, such as a mouse, printer, scanner, modem, and the like, are easily connected via a hub, i.e., a repeater. In the connection structure of a USB system, a hub has one upstream port to be connected to an upper USB port, and a plurality of downstream ports to be connected to lower ports. That is, the number of USB devices that can be connected to one USB host can be increased by using a hub.

In a USB system, one USB port exists at the center of a connection structure, and data is transmitted and received between a USB host of the USB port and a plurality of USB devices. The method of data transmission is determined by the USB communication protocol or specification.

Systematically, a USB device cannot directly communicate with other USB devices, and must pass through a USB host in order to exchange data amongst USB devices. Korean Laid-opened Patent No. 10-2003-0055608 “Printer having USB host controller” has been applied by the present applicant in order to solve this problem.

A printer is disclosed in the above-applied laid-opened patent that can print documents or store scanned data without a computer by directly connecting portable USB storage devices. However, in the case of a printer disclosed in the above application, when a disc within a portable USB storage device connected to a printer is partitioned into a plurality of partitions (hereafter, referred to as a sub-disc), or a plurality of portable USB storage devices are connected to a USB port via a hub, only one of the sub-discs is accessed, and its contents are displayed through a user interface. The other sub-discs cannot be accessed.

### SUMMARY OF THE INVENTION

The present general inventive concept provides an image forming apparatus and method to recognize and access partitions in an external memory device, and display the contents stored in the accessed partitions in a data structure through a user interface.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a method of recognizing partitions in an external memory device including connecting an external memory device to an image forming apparatus, calculating a number of partitions in the connected external memory device, and displaying the calculated partitions.

Further, when the number of partitions in the connected external memory device is calculated, each partition is recognized in a certain order, and a disc name is assigned to each recognized partition based on the recognized order.

Furthermore, when a certain region is analyzed in the partition to which the disc name is assigned, a data structure is constructed corresponding to the certain region stored in the partition.

The certain region may be a FAT (File Allocation Table).

The foregoing and/or other aspects of the present general inventive concept may also be achieved by providing a method of recognizing partitions in external memory devices including connecting a plurality of external memory devices to an image forming apparatus, calculating a number of partitions in a plurality of the connected external memory devices, and displaying the calculated partitions.

Further, in a case where at least one of the plurality of external memory devices attached to the image forming apparatus is detached from the image forming apparatus, a tree structure corresponding to the partitions in the detached external memory device is removed from a user interface.

Furthermore, when the number of the partitions is calculated, each partition is recognized in a certain order and a disc name is assigned to each recognized partition based on the recognized order, and when a certain region is analyzed in the partition to which the disc name is assigned a data structure is constructed corresponding to the certain region stored in the partition.

The foregoing and/or other aspects of the present general inventive concept may also be achieved by providing an image forming apparatus including an interface to connect an external memory device to an image forming apparatus, a partition counter to calculate a number of partitions in the connected external memory device, and a display unit to display the calculated partitions.

Further, the image forming apparatus includes a controller to recognize each partition in a certain order, and assign a disc name to the recognized partitions based on the recognized order.

Furthermore, the image forming apparatus includes a data structure constructor to analyze a certain region in the partition to which the disc name is assigned, and construct a data structure corresponding to the certain region stored in the partition.

The certain region may be a FAT (File Allocation Table).

The foregoing and/or other aspects of the present general inventive concept may also be achieved by providing an image forming apparatus including an interface to connect a plurality of external memory devices to an image forming apparatus, a partition counter to calculate a number of partitions in the plurality of the connected external memory devices, and a display unit to display the calculated partitions.

Further, the image forming apparatus includes a controller to recognize each partition in a certain order, and assign a disc name to the recognized partitions based on the recognized order.

Furthermore, in a case where at least one of the plurality of external memory devices attached to the image forming apparatus is detached from the image forming apparatus a tree structure corresponding to the partitions in the detached external memory device is removed from a user interface.

Yet further still, the image forming apparatus includes a data structure constructor to analyze a certain region in the partition to which the disc name is assigned, and construct a data structure corresponding to the certain region stored in the partition.

The foregoing and/or other aspects of the present general inventive concept may also be achieved by providing a method including calculating a number of disk partitions on a connected external memory device, constructing a data structure based on at least one partition of the at least one external memory device, creating a sub-user interface to display a list of information corresponding to the data structure and any updates made to the data structure, combining the sub-user interface with an existing user interface thereby creating a new updated user interface with an updated data structure, and displaying the existing user interface, and when a change occurs in the list of information corresponding to the data structure, displaying the new updated user interface to allow a user to select desired contents of the updated data structure.

The foregoing and/or other aspects of the present general inventive concept may also be achieved by providing an image forming apparatus including an interface to connect with at least one external memory device, a partition counter that calculates the number of disk partitions on the external memory device, a data structure constructor that constructs a data structure based on at least one partition of the at least one external memory device, a sub-user interface creator that creates a sub-user interface to display a list of information corresponding to the data structure and any updates made to the data structure, a user interface creator that adds the sub-user interface to an existing user interface thereby creating a new updated user interface with an updated data structure, and a display unit that displays the existing user interface, and when a change occurs in the list of information corresponding to the data structure, the new updated user interface is displayed to allow a user to select desired contents of the updated data structure.

The foregoing and/or other aspects of the present general inventive concept may also be achieved by providing a method including judging whether an external memory device has been attached or detached from an image forming apparatus since a last information update of a user interface, determining whether information displayed on the user interface needs to be updated to reflect contents or lack thereof of the attached or detached external memory device, respectively, by performing a check to determine if partitions of the attached or detached external memory device are newly added or no longer available, respectively, and updating the information displayed on the user interface to display the contents of the attached or detached external memory device.

The foregoing and/or other aspects of the present general inventive concept may also be achieved by providing an image forming apparatus including a judging unit to judge whether an external memory device has been attached or detached from an image forming apparatus since a last information update of a user interface, and a controller to determine whether information displayed on the user interface needs to be updated to reflect the contents or lack thereof of the attached or detached external memory device, respectively, by performing a check to determine if partitions of the attached or detached external memory device are newly added or no longer available, respectively, and to update the information displayed on the user interface to display the contents of the attached or detached external memory device.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A and 1B are conceptual views illustrating an exemplary embodiment of the general inventive concept;

FIG. 2 is a block diagram illustrating a configuration of an image forming apparatus according to another exemplary embodiment of the general inventive concept;

FIG. 3 is a flowchart illustrating a method of recognizing partitions in an external memory device connected to the image forming apparatus according to an embodiment of the general inventive concept; and

FIG. 4 illustrates an example of a user interface screen and a sub-user interface screen displayed on a display unit of FIG. 2, according to an embodiment of the general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

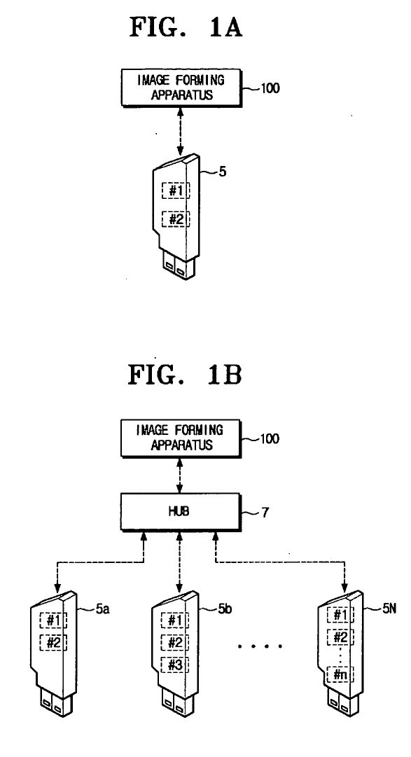

FIGS. 1A and 1B are conceptual views of embodiments of the general inventive concept.

Referring to FIG. 1A, the image forming apparatus 100 is connected to a portable storage device 5 via a USB port (not shown). A disc inside a portable storage device 5 can be partitioned into at least one or more partitions (hereafter, referred to as a sub-discs). The disc inside the portable storage device 5 illustrated in FIG. 1 A is partitioned into two sub-discs #1 and #2.

Referring to FIG. 1B, an image forming apparatus 100 can be connected to a plurality of portable storage devices 5a, 5b . . . 5N via a hub 7, i.e., a repeater. Among the portable devices illustrated in FIG. 1B, the portable storage device 5a has two sub-discs #1 and #2, and the portable storage device 5b has three sub-discs #1, #2 and #3. In other words, the number of sub-discs of each portable storage device may be different.

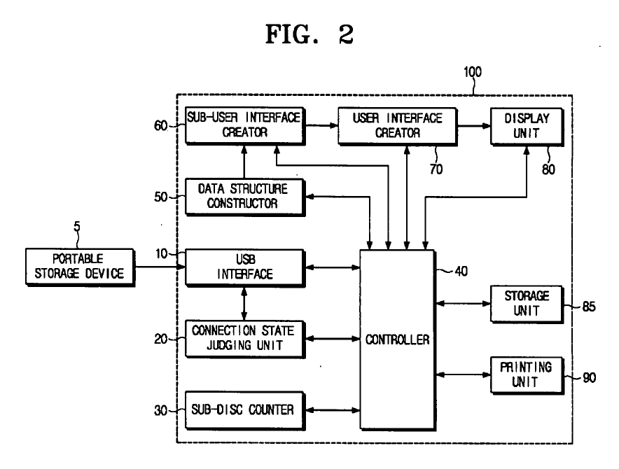

FIG. 2 is a block diagram illustrating a configuration of an image forming apparatus according to an embodiment of the general inventive concept.

Referring to FIG. 2, the image forming apparatus 100 includes a USB interface 10, a connection state judging unit 20, a sub-disc counter 30, a controller 40, a data structure constructor 50, a sub-user interface creator 60, a user interface creator 70, a display unit 80, a storage unit 85, and a printing unit 90. It should be understood that other constituent elements not included in the above example can be included in the image forming apparatus 100.

In FIG. 2, the portable storage device 5 is an example of an external memory device that may include a portable USB memory device, a memory card, and the like. Hereafter, the portable storage device 5 will be described as an example of an external memory device. As explained above, a disc within a portable storage device 5 can be partitioned into at least one or more sub-discs. In addition, although only one portable storage device 5 is connected to the image forming apparatus 100 of FIG. 2, it is apparent that a plurality of portable storage devices 5a, 5b . . . 5N can be connected to the image forming apparatus 100 at the same time via a hub 7, i.e., a repeater, as illustrated in FIG. 1B.

The USB interface 10 provides a USB port interface between the portable storage device 5 and the image forming apparatus 100.

The connection state judging unit 20 judges the connection state of the portable storage device 5 and judges whether the portable storage device 5 is attached to the image forming apparatus 100 or detached from the image forming apparatus 100.

The sub-disc counter 30 confirms the number of sub-discs contained in the connected portable storage device 5.

The controller 40 controls general operations of the image forming apparatus 100. The controller 40 controls the USB interface 10 to receive data from the portable storage device 5. In a case where the data received from the portable storage device 5 is data to be directly printed, the controller 40 transmits the data received from the portable storage device 5 to the printing unit 90, and a printing operation is performed by the printing unit 90. On the other hand, in a case where the data received from the portable storage device 5 is data to be stored, the controller 40 stores the data received from the portable storage device 5 in the storage unit 85.

The controller 40 recognizes each sub-disc in the portable storage device in a certain order, and assigns a disc name to each recognized sub-disc. In addition, in a case where a sub-user interface is added or removed, and the whole user interface is updated as described below, the controller stores the updated user interface in the storage unit 85, and displays it on the display unit 80.

The data structure constructor 50 analyzes a FAT (File Allocation Table) of the sub-disc in the portable storage device 5, and constructs a data structure stored in the sub-disc.

The sub-user interface creator 60 creates a sub-user interface to display a list of the folders stored in a sub-disc of the portable storage device 5 based on the data structure constructed by the data structure constructor 50.

The user interface creator 70 adds the sub-user interface created by the sub-user interface creator 60 to the existing user interface, thereby configuring a new and updated user interface. The updated user interface is stored in the storage unit 85 through the control of the controller 40.

The display unit 80 displays the updated user interface, newly configured by the user interface creator 70, in real-time. In displaying the updated user interface, a user can easily access desired files through the user interface displayed on the display unit 80.

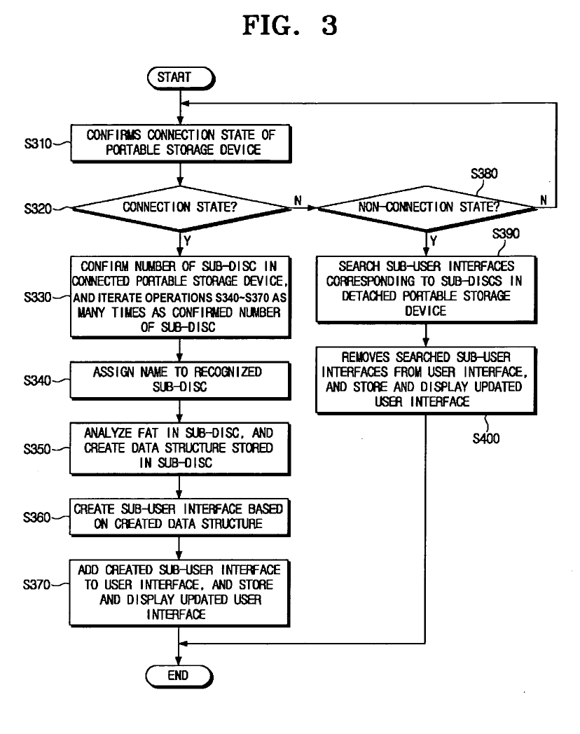

FIG. 3 is a flowchart illustrating a method of recognizing partitions in an external memory device connected to the image forming apparatus 100 of FIG. 2, according to an embodiment of the general inventive concept.

Referring to FIGS. 2 and 3, when a portable storage device 5 is newly attached to the image forming apparatus 100 through the USB interface 10, or when a portable storage device 5 that is already attached to the image forming apparatus 100 is detached from the image forming apparatus 100, the connection state judging unit 20 judges the connection state of the portable storage unit 5 being either attached to or detached from the image forming apparatus 100, at operation S310. Once the connection state information is judged by the connection state judging unit 20, the information is provided to the controller 40.

The judgment of the connection state judging unit 20 is categorized into two states. The first state is the connected state that is judged when a portable storage device 5 is newly connected to the image forming apparatus 100. The second state is the disconnected state that is judged when a portable storage device 5 already connected to the image forming apparatus 100 is detached from the image forming apparatus 100, and is no longer connected to the image forming apparatus 100.

As a result of the judgment of the connection state judging unit 20, if the result is judged as the connected state, i.e., the image forming apparatus 100 and the portable storage device 5 form a new connection at operation S320, the sub-disc counter 30 analyzes the FAT (File Allocation Table) of the sub-disc, and confirms the number of the sub-discs contained in the portable storage device 5 at operation S330. That is, the number of sub-discs that are partitioned on the disc in a portable storage device 5 is confirmed. The controller 40 controls the operation to iterate operations S340 to S370 as many times as needed to acknowledge all of the sub-discs confirmed by the sub-disc counter 30 at operation S330.

Once a sub-disc has been identified by the sub-disc counter 30, the controller 40 assigns a disc name to each sub-disc according to the recognition order of each sub-disc. For example, the disc name of each sub-disc is named such that the sub-disc recognized first is named “disc 1,” the sub-disc recognized second is named “disc 2,” and so on at operation S340.

When a disc name is assigned to a sub-disc, the data structure constructor 50 analyzes the FAT of the sub-disc and constructs the data structure stored in the sub-disc at operation S350. A FAT is generally referred to as a file allocation table or a disc index, and records and manages the size, location, creation date, attributes of all the files existing in a disc, and other information on the disc.

In order to allow a user to easily access the desired files, the sub-user interface creator 60 creates a sub-user interface to display a list of upper folders and lower folders stored in the sub-disc, based on the data structure constructed by the data structure constructor 50, at operation S360.

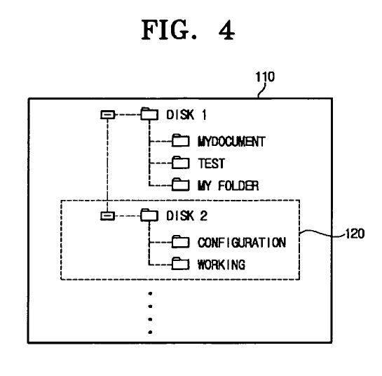

The user interface creator 70 adds the created sub-user interface to the user interface that is already created, thereby configuring a new user interface, at operation S370. The controller 40 stores the newly updated user interface in the storage unit 85, and displays it in real-time on the display unit 80, at operation S370. FIG. 4 illustrates an example of a user interface screen and a sub-user interface screen displayed on the display unit 80 according to an example embodiment of the present general inventive concept. In FIG. 4, 120 denotes a sub-user interface screen created by the sub-user interface creator 60, and 110 denotes a whole user interface screen. It is to be understood that a change to the existing user interface screen updates the whole user interface screen. For example, when a newly created sub-user interface screen is added to the existing user interface screen, the whole user interface screen is updated.

Since a list of the folders stored in the sub-discs of a portable storage device 5 is displayed is display 80, a user can easily access the files stored in the portable storage device 5, thereby conveniently performing various operations with the desired files.

On the other hand, as a result of the judgment of the connection state judging unit 20, at operation S310, in the case of the disconnected state that is judged as having a portable storage device 5 detached from the image forming apparatus 100, at operation S380, the controller 40 searches the sub-user interfaces corresponding to the sub-discs in the detached portable storage device 5, at operation S390.

The controller 40 removes the searched sub-user interfaces from the user interface, and stores the updated user interface in the storage unit 85, at operation S400. In addition, the controller 40 provides the updated user interface to be displayed in real-time on the display unit 80, at operation S400.

In a case where the portable storage device 5 is detached from the image forming apparatus 100, since the updated user interface is displayed in real-time on the display unit 80, a user is not allowed to access the sub-discs in the disconnected portable storage device 5.

A method of recognizing partitions in an external memory device (e.g., the portable storage device 5) according to an embodiment of the present general inventive concept may be performed by the controller 40. The method may include judging whether the external memory device has been attached or detached from the image forming apparatus 100 since a last information update of the user interface 110, determining whether information displayed on the user interface 110 needs to be updated to reflect contents or lack of contents of the attached or detached external memory device, respectively, by performing a check to determine if partitions of the attached or detached external memory device are newly added or no longer available, respectively, and updating the information displayed on the user interface 110 to reflect the contents of the attached or detached external memory device.

As described above, according to the general inventive concept, even in a case where a disc in a portable storage device is partitioned into a plurality of sub-discs, all the partitioned sub-discs are recognized, and the recognized contents are displayed on the display unit. Accordingly, even in a case where a disc in a portable storage device is partitioned into a plurality of sub-discs, a user can access all of the contents stored in each sub-disc.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of recognizing partitions in an external memory, the method comprising:
connecting an external memory device to an image forming apparatus;
calculating a number of partitions in the connected external memory device; and
displaying the calculated partitions.

2. The method as claimed in claim 1, wherein when the number of partitions in the connected external memory device is calculated, each partition is recognized in a certain order, and a disc name is assigned to each recognized partition based on the recognized order.

3. The method as claimed in claim 2, wherein when a certain region is analyzed in the partition to which the disc name is assigned, a data structure is constructed corresponding to the certain region stored in the partition.

4. The method as claimed in claim 3, wherein the certain region is a File Allocation Table (FAT).

5. A method of recognizing partitions in external memory devices, the method comprising:
connecting a plurality of external memory devices to an image forming apparatus;
calculating a number of partitions in a plurality of the connected external memory devices; and
displaying the calculated partitions.

6. The method as claimed in claim 5, wherein in a case where at least one of the plurality of external memory devices attached to the image forming apparatus is detached from the image forming apparatus, a tree structure corresponding to the partitions in the detached external memory device is removed from a user interface.

7. The method as claimed in claim 5, wherein, when the number of the partitions is calculated, each partition is recognized in a certain order and a disc name is assigned to each recognized partition based on the recognized order, and when a certain region is analyzed in the partition to which the disc name is assigned a data structure is constructed corresponding to the certain region stored in the partition.

8. An image forming apparatus comprising:
an interface to connect an external memory device to an image forming apparatus;
a partition counter to calculate a number of partitions in the connected external memory device; and
a display unit to display the calculated partitions.

9. The apparatus as claimed in claim 8, further comprising:
a controller to recognize each partition in a certain order, and to assign a disc name to the recognized partitions based on the recognized order.

10. The apparatus as claimed in claim 9, further comprising:
a data structure constructor to analyze a certain region in the partition to which the disc name is assigned, and to construct a data structure corresponding to the certain region stored in the partition.

11. The apparatus as claimed in claim 10, wherein the certain region is a FAT (File Allocation Table).

12. An image forming apparatus comprising:
an interface to connect a plurality of external memory devices to an image forming apparatus;
a partition counter to calculate a number of partitions in each of the plurality of the connected external memory devices; and
a display unit to display the calculated partitions.

13. The apparatus as claimed in claim 12, further comprising:
a controller to recognize each partition in a certain order, and to assign a disc name to the recognized partitions based on the recognized order.

14. The apparatus as claimed in claim 12, wherein, in a case where at least one of the plurality of external memory devices attached to the image forming apparatus is detached from the image forming apparatus, a tree structure corresponding to the partitions in the detached external memory device is removed from a user interface.

15. The apparatus as claimed in claim 13, further comprising:
a data structure constructor to analyze a certain region in the partition to which the disc name is assigned, and to construct a data structure corresponding to the certain region stored in the partition.

16. A method comprising:
calculating a number of disk partitions in a connected external memory device;
constructing a data structure based on at least one partition of the at least one external memory device;
creating a sub-user interface to display a list of information corresponding to the data structure and any updates made to the data structure;
combining the sub-user interface with an existing user interface to create a new updated user interface with an updated data structure; and
displaying the existing user interface, and when a change occurs in the list of information corresponding to the data structure, displaying the new updated user interface in real time to allow a user to select desired contents of the updated data structure.

17. A method comprising:
judging whether an external memory device has been attached or detached from an image forming apparatus since a last information update of a user interface;
determining whether information displayed on the user interface needs to be updated to reflect contents or lack of contents of the attached or detached external memory device, respectively, by performing a check to determine if partitions of the attached or detached external memory device are newly added or no longer available, respectively; and
updating the information displayed on the user interface to reflect the contents of the attached or detached external memory device.
